(19) United States
(12) Patent Application Publication
(10) Pub. No.: US 2017/0200409 A1
(43) Pub. Date: Jul. 13, 2017

(54) REPAIR CIRCUIT, DISPLAY SUBSTRATE AND RELATED DISPLAY PANEL, AND REPAIR METHOD

(71) Applicants: BOE TECHNOLOGY GROUP CO., LTD., Beijing (CN); HEFEI XINSHENG OPTOELECTRONICS TECHNOLOGY CO., LTD., Hefei (CN)

(72) Inventors: Jian ZHAO, Beijing (CN); Mo CHEN, Beijing (CN)

(73) Assignees: BOE Technology Group Co., Ltd., Beijing (CN); Hefei Xinsheng Optoelectronics Technology Co., Ltd., Hefei (CN)

(21) Appl. No.: 15/325,339

(22) PCT Filed: Feb. 22, 2016
(86) PCT No.: PCT/CN2016/074259

§ 371 Date: Jan. 10, 2017

(30) Foreign Application Priority Data
Sep. 10, 2015 (CN) 201510575196.1

(51) Int. Cl. G09G 3/20

(52) U.S. Cl. CPC G09G 3/2092; G09G 2330/08; G09G 2310/08; G09G 2310/0243; G09G 2300/0426

(57) ABSTRACT

A repair circuit, a display substrate, and a related display panel and a repair method are disclosed. The repair circuit comprises a repair unit and at least three repair lines electrically connected to the repair unit. The repair unit comprises a charging module, an input module, and a pull-down module. The charging module is configured to charge when a first level signal is transmitted on a first repair line and discharge after the transmission of the first level signal is completed on the first repair line. The input module is configured to provide a first driving signal to a second repair line when the charging module discharges. The pull-down module is configured to pull down a discharge level of the charging module and pull down an output level of by the input module when the first level signal is transmitted on a third repair line. According to embodiments of the present disclosure, the signals transmitted on the disconnected drive lead are reloaded to the gate line connected to the disconnected drive lead by welding the corresponding repair points and inputting the signals from the repair unit, so as to realize normal use of the display panel.

### CROSS-REFERENCE TO RELATED APPLICATION

The present application claims the benefit and priority of Chinese Patent Application No. 201510575196.1 filed on Sep. 10, 2015, the entire content of which is incorporated herein by reference as a part of the present application.

### TECHNICAL FIELD

Exemplary embodiments of the present disclosure relate to a repair circuit, a display substrate and a related display panel, and a repair method.

### BACKGROUND

Display substrate is usually divided into two parts: a display region and a non-display region. The display region is provided with gate lines, data lines, and pixel units etc. to realize image display. The non-display region is provided with a drive unit and drive leads (e.g., drive leads of the gate lines) to implement dynamic image presentation in the display region.

Because the fabricating process and structure of the display substrate are complex, the drive leads of a part of the gate lines will be damaged during the fabricating procedure, and thus be disconnected. Moreover, the drive leads of the gate lines may be disconnected due to corrosion, scratch and overburning during the display. The disconnection of the drive leads of the gate lines would cause driving signals not to be provided to the gate lines connected to the drive leads, such that the pixel units connected to the gate lines are unable to display image, and thus the display substrate cannot work normally.

### SUMMARY

Exemplary embodiments of the present disclosure provide a repair circuit, a display substrate, a related display panel and a repair method, which can reload the signal transmitted on the disconnected drive lead to the gate line connected thereto by welding the corresponding repair points and inputting the signals from the repair unit, so as to realize the normal use of the display panel.

According to a first aspect of the present disclosure, there is provided a repair circuit, which comprises a repair unit and at least three repair lines electrically connected to the repair unit. The repair unit comprises a charging module configured to charge when a first level signal is transmitted on a first repair line and discharge after the transmission of the first level signal is completed on the first repair line, an input module configured to provide a first driving signal to a second repair line when the charging module discharges, and a pull-down module configured to pull down a discharge level of the charging module and pull down an output level of the input module when the first level signal is transmitted on a third repair line.

According to an exemplary embodiment of the present disclosure, the repair unit comprises a first signal input terminal, a second signal input terminal and a signal output terminal. The first signal input terminal is electrically connected to the first repair line, the second signal input terminal is electrically connected to the third repair line, and the signal output terminal is electrically connected to the second repair line.

According to an exemplary embodiment of the present disclosure, the repair unit further comprises a clock signal input terminal and a low level signal input terminal. The charging module comprises a control terminal, a reference terminal, and a charging/discharging module. The input module comprises a control terminal, an input terminal, and an output terminal. The pull-down module comprises a control terminal, an input terminal, a first output terminal, and a second output terminal. The control terminal of the charging module is used as the first signal input terminal of the repair unit. The charging/discharging terminal of the charging module is electrically connected to the control terminal of the input module and the first output terminal of the pull-down module. The reference terminal of the charging module is electrically connected to the output terminal of the input module and the second output terminal of the pull-down module. The input terminal of the input module is used as the clock signal input terminal of the repair unit, and the output terminal of the input module is used as the signal output terminal of the repair unit. The control terminal of the pull-down module is used as the second signal input terminal of the repair unit, and the input terminal of the pull-down module is used as the low level signal input terminal of the repair unit.

According to an exemplary embodiment of the present disclosure, the charging module comprises a first thin film transistor (TFT) and a capacitor. A first electrode and a gate electrode of the first TFT are electrically connected to be used as the control terminal of the charging module, and a second electrode of the first TFT is used as the charging/discharging terminal of the charging module. One electrode of the capacitor is electrically connected to the second electrode of the first TFT, and the other electrode of the capacitor is used as the reference terminal of the charging module.

According to an exemplary embodiment of the present disclosure, the input module comprises a second TFT. A first electrode of the second TFT is used as the input terminal of the input module, a gate electrode of the second TFT is used as the control terminal of the input module, and a second electrode of the second TFT is used as the output terminal of the input module.

According to an exemplary embodiment of the present disclosure, the pull-down module comprises a third TFT and a fourth TFT. A first electrode of the third TFT is used as the first output terminal of the pull-down module. A gate electrode of the third TFT is electrically connected to a gate electrode of the fourth TFT and used as the control terminal of the pull-down module. A second electrode of the third TFT is electrically connected to a second electrode of the fourth TFT, and used as the input terminal of the pull-down module. A first electrode of the fourth TFT is used as the second output terminal of the pull-down module.

According to an exemplary embodiment of the present disclosure, the first electrode is a source electrode of the TFT, and the second electrode is a drain electrode of the TFT.

According to an exemplary embodiment of the present disclosure, the first level signal is a high level signal.

According to a second aspect of the present disclosure, there is provided a display substrate which comprises the above described repair circuit. The repair lines are disposed in a non-display region of the display substrate, and each of the repair lines intersects with and is insulated from each drive lead of the display substrate. A repair points is formed at each intersection.

According to an exemplary embodiment of the present disclosure, the display substrate further comprises gate lines disposed in its display region, and the gate lines are disposed on the same layer as the drive leads.

According to an exemplary embodiment of the present disclosure, the display substrate further comprises data lines, and the repair lines are disposed on the same layer as the data lines.

According to an exemplary embodiment of the present disclosure, the repair lines are disposed within a region adjacent to the display region in the non-display region of the display substrate.

According to an exemplary embodiment of the present disclosure, the repair lines are disposed on one side of the display substrate, or disposed on two sides of the display substrate.

According to a third aspect of the present disclosure, there is provided a display panel which comprises the above-described display substrate.

According to a fourth aspect of the present disclosure, there is provided a repair method for the above-described display substrate. The method comprises: welding a repair point formed at an intersection of a first repair line and a drive lead adjacent to a disconnected drive lead, welding a repair point formed at an intersection of a second repair line and the disconnected drive lead, and welding a repair point formed at an intersection of a third repair line and another drive lead adjacent to the disconnected drive lead; obtaining, by the repair unit, a first adjacent driving signal transmitted on a drive lead adjacent to the disconnected drive lead from the first repair line, and obtaining a second adjacent driving signal transmitted on another drive lead adjacent to the disconnected drive lead from the third repair line, generating a first driving signal for driving a gate line connected to the disconnected drive lead based on the first adjacent driving signal and the second adjacent driving signal, and providing the first driving signal to the gate line connected to the disconnected drive lead through the second repair line.

### BRIEF DESCRIPTION OF DRAWINGS

In order to describe the technical solutions of embodiments of the present disclosure or that of the prior art more clearly, the accompanying drawings required for describing the embodiments of the present disclosure or the prior art will be briefly introduced below. Apparently, the accompanying drawings in the following description are merely some embodiments of the present disclosure. To those of ordinary skills in the art, other accompanying drawings may also be derived from these accompanying drawings without creative efforts.

FIG. 1 is a schematic structural diagram of the display substrate according to an embodiment of the present disclosure;

FIG. 2 is a schematic structural diagram of a part of the display substrate before the drive lead is damaged according to an embodiment of the present disclosure;

FIG. 3 is a schematic structural diagram of the part of the display substrate after the damage part of the drive lead is repaired according to an embodiment of the present disclosure;

FIG. 4 is a structural block diagram of the repair unit according to an embodiment of the present disclosure;

FIG. 5 is a circuit diagram of the repair unit according to an embodiment of the present disclosure;

FIG. 6 is a schematic flow chart of the repair method for the display substrate according to an embodiment of the present disclosure; and

FIG. 7 is a sequential chart of repairing the display substrate according to an embodiment of the present disclosure.

### DETAILED DESCRIPTION

Technical solutions in embodiments of the present disclosure will be described clearly and completely below, in conjunction with the accompanying drawings in the embodiments of the present disclosure. Obviously, the described embodiments are merely some but not all of the embodiments of the present disclosure. All other embodiments obtained by those of ordinary skills in the art based on the embodiments of the present disclosure without creative efforts shall fall within the protection scope of the present disclosure.

It should be noted that in the description of the present disclosure, terms “above”, “below”, “top”, “bottom” and the like which indicate orientations or positional relationships are based on the orientation or positional relationships shown by the accompanying drawings, and they are merely used for describing the present disclosure and simplifying the description, rather than indicating or implying that the denoted devices or elements must have the specific orientation, or be constructed and operated by specific orientations, and thus they cannot be understood as limitation of the present disclosure.

In addition, in the present disclosure, terms “first”, “second” and “third” are merely for description purpose, rather than being understood as indicating or implying relative importance. The term “a plurality of” refers to two or more than two, unless otherwise clearly defined.

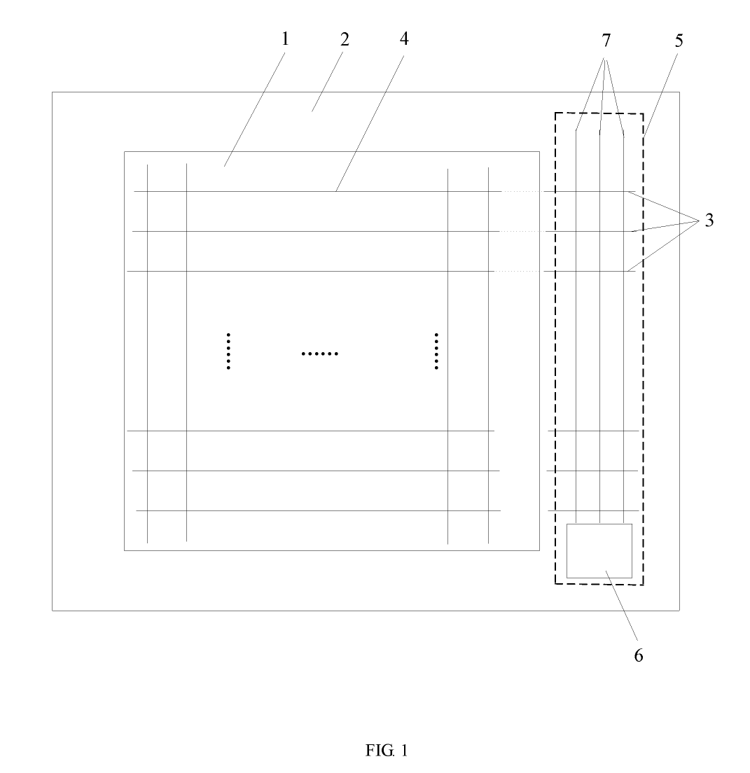

Detailed description of the embodiments of the present disclosure will be provided below in conjunction with FIGS. 1 to 7.

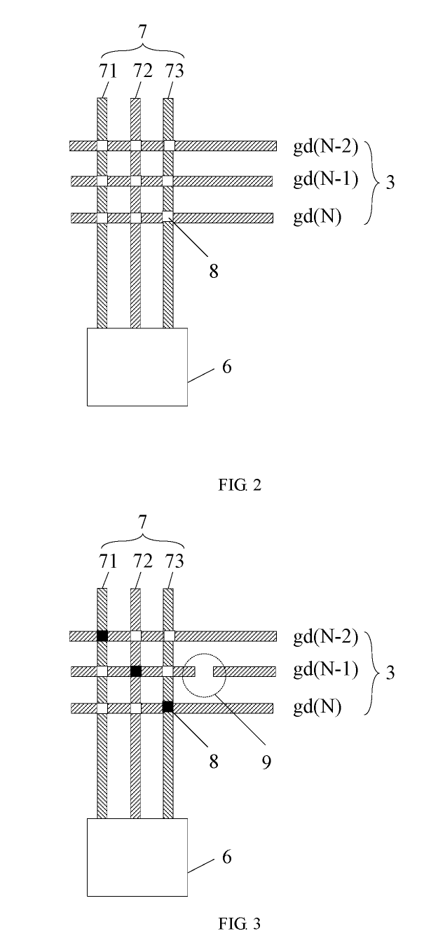

Referring to FIG. 1, the display substrate according to an embodiment of the present disclosure may be divided into a display region 1 and a non-display region 2. The non-display region 2 includes a plurality of drive leads 3, and each of the drive leads 3 is connected to a gate line 4 disposed in display region 1. The display substrate further includes at least one repair circuit 5. Each repair circuit 5 includes a repair unit 6 and three repair lines 7 (e.g., a first repair line 71, a second repair line 72, and a third repair line 73 as shown in FIG. 2) disposed in the non-display region 2. The repair unit 6 is electrically connected to the three repair lines 7.

According to an embodiment of the present disclosure, the drive leads 3 and the gate lines 4 are disposed on the same layer, such that the fabricating process of the display substrate is simplified.

According to an embodiment of the present disclosure, the display substrate further includes data lines. The repair lines 7 and the data lines (not shown) are disposed on the same layer, such that the fabricating process of the display substrate is simplified.

According to an embodiment of the present disclosure, the repair lines 7 may be disposed in a region adjacent to the display region 1 of the non-display region 2. According to an embodiment of the present disclosure, the repair lines 7 may be disposed on one side of the display substrate, or on two sides of the display substrate. In some embodiments, the drive lead 3 may drive the display region 1 in a unilateral driving manner or in bilateral driving manner. Then the repair lines in the non-display region 2 disposed on one side or two sides of the display region 1 may repair the drive leads 3 on one side or two sides of the display region 1, which will not be repeated herein.

Referring to FIG. 2, each of the repair lines 7 (e.g., the first repair line 71, the second repair line 72, and the third repair line 73) intersects with and is insulated from the drive leads 3 (e.g., the (N-2)th drive lead gd(N-2), the (N-1)th drive lead gd(N-1), and the Nth drive lead gd(N)). There are nine repair points 8 formed at the intersections. Referring to FIG. 3, the repair unit 6 is electrically connected to each of the repair lines 7. If the (N-1)th drive lead gd(N-1) is disconnected (e.g., there is a disconnected point 9 as shown in FIG. 3), the repair unit 6 may obtain the first adjacent driving signal transmitted on the (N-2)th drive lead gd(N-2) through the first repair line 71 after the repair point 8 formed at the intersection of the first repair line 71 and the (N-2)th drive lead gd(N-2) is welded, and may obtain a second adjacent driving signal transmitted on the Nth drive lead gd(N) through the third repair line 73 after the repair point 8 formed at the intersection of the third repair line 73 and the Nth drive lead gd(N) is welded. Then the repair unit 6 may generate a first driving signal for driving the gate line 4 connected to the (N-1)th drive lead gd(N-1) based on the obtained first adjacent driving signal transmitted on the (N-2)th drive lead gd(N-2) and the second adjacent driving signal transmitted on the Nth drive lead gd(N), and provide the first driving signal to the gate line 4 connected to the (N-1)th drive lead gd(N-1) through the second repair line 72 after the repair point 8 formed at the intersection of the second repair line 72 and the (N-1)th drive lead gd(N-1) is welded.

In some embodiments, the display substrate may be provided with a plurality of drive leads 3 and at least one repair circuit 5. The repair circuit 5 includes the repair unit 6 and three repair lines 7 disposed on the non-display region 2. The repair points 8 are formed at the intersections of the repair lines 7 and the drive leads 3. If the (N-1)th drive lead gd(N-1) is disconnected, the repair points 8 may be welded, and thus the first repair line 71 may be connected to the (N-2)th drive lead gd(N-2), the second repair line 72 may be connected to the (N-1)th drive lead gd(N-1), and the third repair line 73 may be connected to the Nth drive lead gd(N). Then the first driving signal for driving the gate line 4 connected to the (N-1)th drive lead gd(N-1) may be generated based on the driving signals (e.g., the first adjacent driving signal and the second adjacent driving signal) transmitted on the drive leads adjacent to the disconnected (N-1)th drive lead gd(N-1), such that the pixel unit driven by the gate line 4 connected to the (N-1)th drive lead gd(N-1) may display normally. In this way, the display substrate can operate normally.

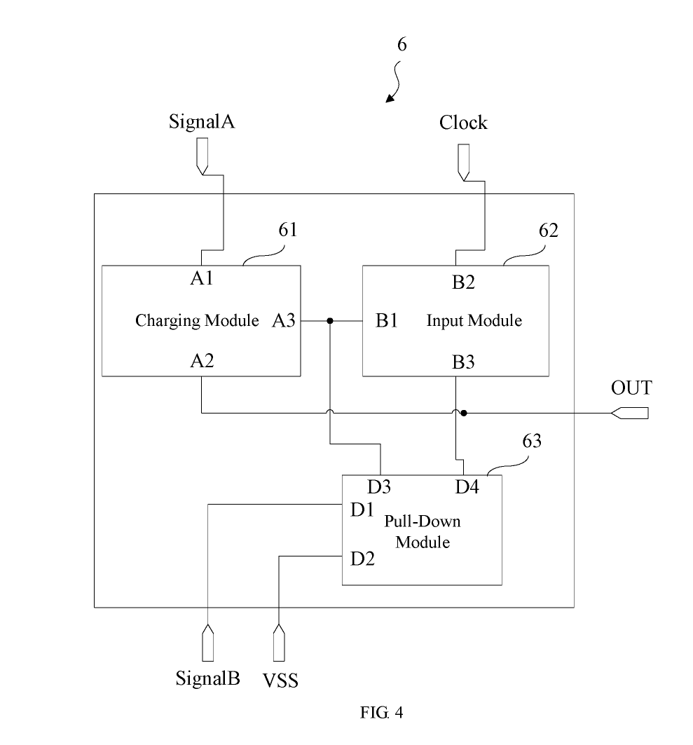

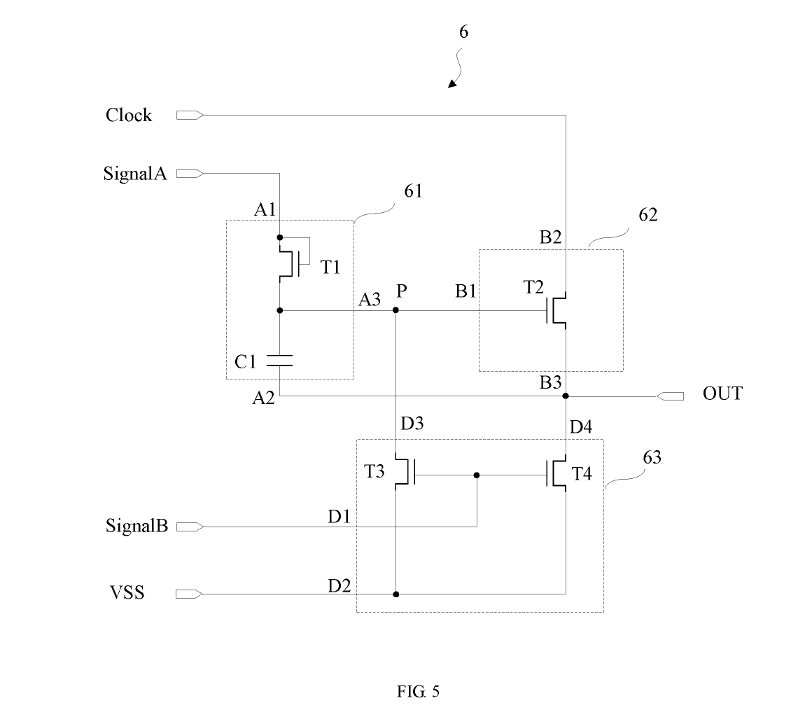

As shown in FIG. 4, the repair unit 6 may include a charging module 61, an input module 62, and a pull-down module 63. The charging module 61 may charge when a high level signal is transmitted on the first repair line 71, and discharge after the transmission of the high level signal is completed on the first repair line. The input module 62 may provide a first driving signal to the second repair line 72 when the charging module 61 discharges. The pull-down module 63 may pull down a discharge level of the charging module 61 and pull down an output level of the input module 62 when the high level signal is transmitted on the third repair line 72.

The repair unit 6 may also comprise a first signal input terminal Signal A connected to an external signal line, a second signal input terminal Signal B, a clock signal input terminal Clock, a low level signal input terminal VSS, and a signal output terminal OUT. The first signal input terminal Signal A is electrically connected to the first repair line 71. The second signal input terminal Signal B is electrically connected to the third repair line 73. The clock signal input terminal Clock is electrically connected to the clock signal line. The low level signal input terminal VSS is electrically connected to the low level signal line. The signal output terminal OUT is electrically connected to the second repair line 72.

According to an embodiment of the present disclosure, the charging module 61 comprises a control terminal A1, a reference terminal A2, and a charging/discharging terminal A3. The input module 62 comprises a control terminal B1, an input terminal B2, and an output terminal B3. The pull-down module 63 comprises a control terminal D1, an input terminal D2, a first output terminal D3, and a second output terminal D4. The control terminal A1 of the charging module 61 is used as the first signal input terminal Signal A of the repair unit 6, and the charging/discharging terminal A3 of the charging module 61 is electrically connected to the control terminal B1 of the input module 62 and the first output terminal D3 of the pull-down module 63. The reference terminal A2 of the charging module 61 is electrically connected to the output terminal B3 of the input module 62 and the second output terminal D4 of the pull-down module 63. The input terminal B2 of the input module 62 is used as the clock signal input terminal Clock of the repair unit 6, and the output terminal B3 of the input module 62 is used as the signal output terminal OUT of the repair unit 6. The control terminal D1 of the pull-down module 63 is used as the second signal output terminal B of the repair unit 6, and the input terminal D2 of the pull-down module 63 is used as the low level signal input terminal VSS of the repair unit 6.

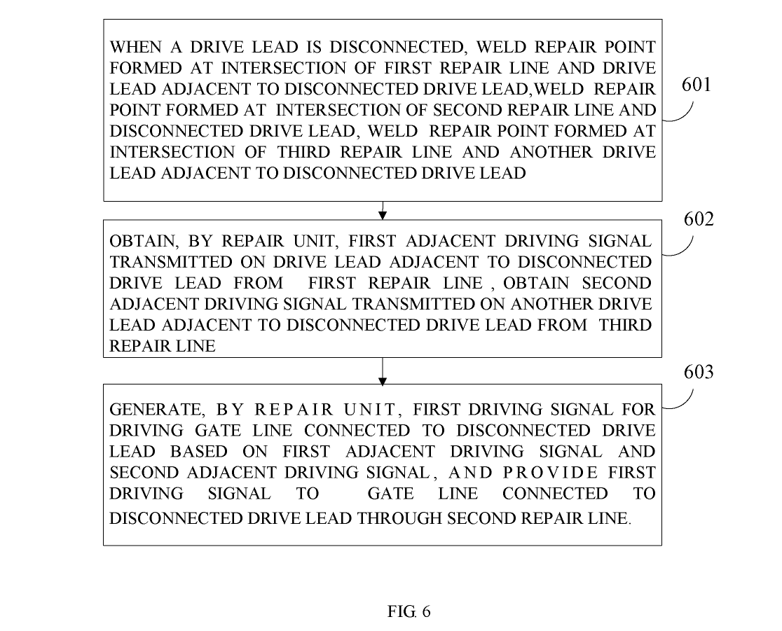

As shown in FIG. 5, which is the circuit diagram of the repair unit according to an embodiment of the present disclosure, the charging module 61 may include a first TFT T1 and a capacitor C1. A source electrode and a gate electrode of the first TFT T1 are electrically connected to be used as the control terminal A1 of the charging module 61, and the drain electrode of the first TFT T1 is used as the charging/discharging terminal A3 of the charging module 61. One electrode of the capacitor C1 is electrically connected to the drain electrode of the first TFT T1, and the other electrode of the capacitor C1 is used as the reference terminal A2 of the charging module 61.

As shown in FIG. 5, the input module 62 may include a second TFT T2. The source electrode of the second TFT T2 is used as the input terminal B2 of the input module 62, the gate electrode of the second TFT T2 is used as the control terminal B1 of the input module 62, and the drain electrode of the second TFT T2 is used as the output terminal B3 of the input module 62.

As shown in FIG. 5, the pull-down module 63 may include a third TFT T3 and a fourth TFT T4. A source electrode of the third TFT T3 is used as the first output terminal D3 of the pull-down module 63. A gate electrode of the third TFT T3 is electrically connected to a gate electrode of the fourth TFT T4, and used as the control terminal D1 of the pull-down module 63. A drain electrode of the third TFT T3 is electrically connected to the drain electrode of the fourth TFT T4, and used as the input terminal D2 of the pull-down module 63. A source electrode of the fourth TFT T4 is used as the second output terminal D4 of the pull-down module 63.

According to an embodiment of the present disclosure, the first TFT T1, the second TFT T2, the third TFT T3, and the fourth TFT T4 may be N-type TFTs, such that the fabricating process is simplified.

It should be noted that the first TFT T1, the second TFT T2, the third TFT T3, and the fourth TFT T4 may also be P-type TFTs. In this case, the corresponding driving signals may be adjusted accordingly, which will not be repeated herein.

According to an embodiment of the present disclosure, the first TFT T1, the second TFT T2, the third TFT T3, and the fourth TFT T4 may also be bottom-gate-type TFT, such that the fabricating process is simplified.

FIG. 6 shows the repair method for the display substrate according to the embodiments of the present disclosure. As shown in FIG. 6, at 601, when a drive lead is disconnected, the repair point formed at the intersection of the first repair line and a drive lead adjacent to the disconnected drive lead is welded, the repair point formed at an intersection of the second repair line and the disconnected drive lead is welded, and the repair point formed at the intersection of the third repair line and another drive lead adjacent to the disconnected drive lead is welded. At 602, the repair unit obtains the first adjacent driving signal transmitted on the drive lead adjacent to the disconnected drive lead from the first repair line, and obtains the second adjacent driving signal transmitted on another drive lead adjacent to the disconnected drive lead from the third repair line. At 603, the repair unit generates the first driving signal for driving the gate line connected to the disconnected drive lead based on the first adjacent driving signal and the second adjacent driving signal, and provides the first driving signal to the gate line connected to the disconnected drive lead through the second repair line.

In some embodiments, if a drive lead is disconnected, the repair point formed at the intersection of the first repair line and one drive lead adjacent to the disconnected drive lead may be welded, the repair point formed at the intersection of the second repair line and the disconnected drive lead may be welded, and the repair point formed at the intersection of the third repair line and another drive lead adjacent to the disconnected drive lead may be welded, and thus the signals transmitted on the drive leads adjacent to the disconnected drive lead can be inputted into the repair unit. The repair unit may generate the first driving signal for driving the gate line connected to the disconnected drive lead based on the obtained first adjacent driving signal and the second adjacent driving signal, and transmit the first driving signal to the gate line connected to the disconnected drive lead through the second repair line.

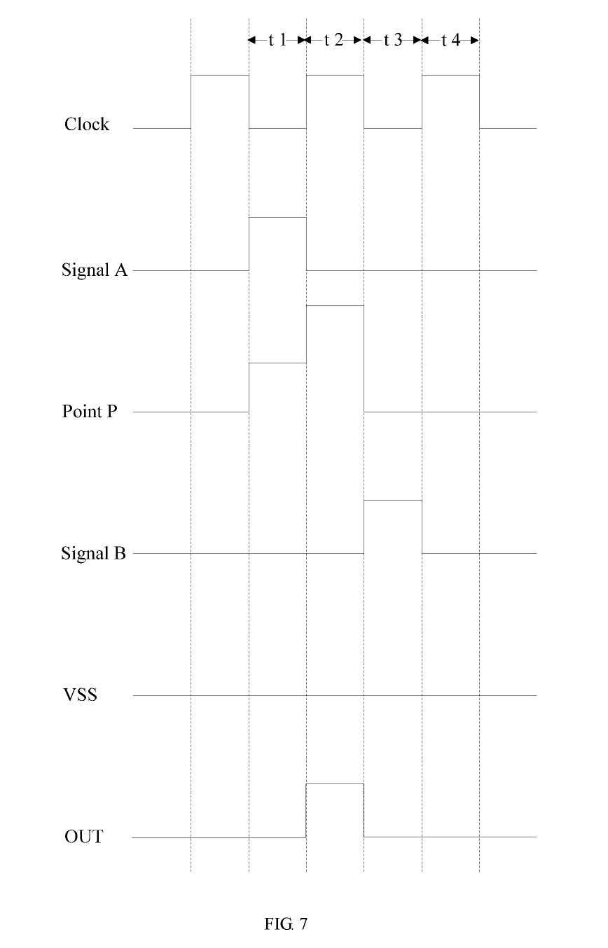

Detailed description will be made by referring to FIG. 6 and FIG. 7 illustrating the sequential chart of the input signals corresponding to the specific structure of the repair unit.

During the first time period t1, the low level signal is input to the clock signal terminal Clock, the high level signal is input to the first signal input terminal Signal A, the low level signal is input to the second signal input terminal Signal B, and the low level signal is input to the low level signal terminal VSS.

In this period, the high level signal is input to the first signal input terminal Signal A, then the first TFT T1 is ON and the point P (as shown in FIG. 5) is at high level. The capacitor C1 starts to charge and the second TFT T2 is also ON. Accordingly, the low level signal is input to the second signal input terminal Signal B, then the third TFT T3 and the fourth TFT T4 are OFF, and thus the signal output terminal OUT outputs the low level signal from the clock signal terminal Clock.

During the second time period t2, the high level signal is input to the clock signal terminal Clock, the low level signal is input to the first signal input terminal Signal A, the low level signal is input to the second signal input terminal Signal B, and the low level signal is input to the low level signal terminal VSS.

In this period, the low level signal is input to the first signal input terminal Signal A, then the first TFT T1 is OFF, and the capacitor C1 starts to discharge. The point P (as shown in FIG. 5) is still at high level, and the second TFT T2 is ON. Accordingly, the low level signal is input to the second signal input terminal Signal B, then the third TFT T3 and the fourth TFT T4 are OFF, and thus the signal output terminal OUT outputs the high level signal from the clock signal terminal Clock.

During the third time period t3, the low level signal is input to the clock signal terminal Clock, the low level signal is input to the first signal input terminal Signal A, the high level signal is input to the second signal input terminal Signal B, and the low level signal is input to the low level signal terminal VSS.

In this period, the low level signal is input to the first signal input terminal Signal A, then the first TFT T1 is OFF, and the discharging of the capacitor C1 is completed. The point P (as shown in FIG. 5) becomes at low level, and the second TFT T2 is OFF. Accordingly, the high level signal is input to the second signal input terminal Signal B, then the third TFT T3 and the fourth TFT T4 are ON, and thus the signal output terminal OUT outputs the low level signal from the low level signal input terminal Vss.

During the fourth time period t4, the high level signal is input to the clock signal terminal Clock, the low level signal is input to the first signal input terminal Signal A, the low level signal is input to the second signal input terminal Signal B, and the low level signal is input to the low level signal terminal VSS.

In this period, the low level signal is input to the first signal input terminal Signal A, then the first TFT T1 is OFF, the point P (as shown in FIG. 5) maintains at low level, and the second TFT T2 is OFF. Accordingly, the low level signal is input to the second signal input terminal Signal B, then the third TFT T3 and the fourth TFT T4 are OFF, and thus the signal output terminal OUT outputs the low level signal.

It should be noted that in the sequential chart as shown in FIG. 7, the increased potential amplitude at the point P during the charging and discharging period is illustrative and merely an explanation of the present disclosure, rather than limitation of the present disclosure.

According to some embodiments of the present disclosure, the driving signal transmitted on the disconnected drive lead 3 can be regenerated by combining the driving signals transmitted on the drive leads 3 adjacent to the disconnected drive lead 3 with the external clock signals, based on the structure of the repair unit 6 and the input of the corresponding timing signals, such that the display panel can continue to be used normally.

According to an embodiment of the present disclosure, there is further provided a display panel which includes the display substrate according to the embodiments of the present disclosure.

The advantageous effects according to the embodiments of the present disclosure are as follows. The display substrate may be provided with a plurality of drive leads and at least one repair circuit. Each repair circuit may include the repair unit and three repair lines (e.g. a first repair line, a second repair line, and a third repair line) disposed on the non-display region. The repair points may be formed at the intersections of the repair lines and the drive leads. If the (N-1)th drive lead is disconnected, by welding the repair points, the first repair line can be electrically connected to the (N-2)th drive lead, the second repair line can be electrically connected to the (N-1)th drive lead, and the third repair line can be electrically connected to the Nth drive lead, such that the first driving signal for driving the gate line connected to the (N-1)th drive lead may be regenerated based on the driving signal transmitted on the drive leads adjacent to the disconnected (N-1)th drive lead, and thus the pixel units driven by the gate line connected to the (N-1)th drive lead display normally. In this way, the display substrate can operate normally.

The abovementioned embodiments are merely the embodiments of the present disclosure, but the scope of protection of the present disclosure is not limited thereto. Any variation or substitution easily conceivable to a person of ordinary skills in the art within the technical scope disclosed in the present disclosure shall fall into the protection scope of the present disclosure. Therefore, the protection scope of the present disclosure shall be subject to the protection scope of the claims.

1. A repair circuit, comprising a repair unit and at least three repair lines electrically connected to the repair unit, the repair unit comprising:
a charging module configured to charge when a first level signal is transmitted on a first repair line and discharge after the transmission of the first level signal is completed on the first repair line;
an input module configured to provide a first driving signal to a second repair line when the charging module discharges; and
a pull-down module configured to pull down a discharge level of the charging module and pull down an output level of the input module when the first level signal is transmitted on a third repair line.

2. The repair circuit according to claim 1, wherein the repair unit comprises a first signal input terminal, a second signal input terminal, and a signal output terminal, wherein the first signal input terminal is electrically connected to the first repair line, the second signal input terminal is electrically connected to the third repair line, and the signal output terminal is electrically connected to the second repair line.

3. The repair circuit according to claim 2, wherein the repair unit further comprises a clock signal input terminal and a low level signal input terminal, the charging module comprises a control terminal, a reference terminal, and a charging/discharging terminal, the input module comprises a control terminal, an input terminal, and an output terminal, and the pull-down module comprises a control terminal, an input terminal, a first output terminal, and a second output terminal,
wherein the control terminal of the charging module is used as the first signal input terminal of the repair unit, the charging/discharging terminal of the charging module is electrically connected to the control terminal of the input module and the first output terminal of the pull-down module, and the reference terminal of the charging module is electrically connected to the output terminal of the input module and the second output terminal of the pull-down module,
wherein the input terminal of the input module is used as the clock signal input terminal of the repair unit, and the output terminal of the input module is used as the signal output terminal of the repair unit, and
wherein the control terminal of the pull-down module is used as the second signal input terminal of the repair unit, and the input terminal of the pull-down module is used as the low level signal input terminal of the repair unit.

4. The repair circuit according to claim 3, wherein the charging module comprises a first thin film transistor (TFT) and a capacitor,
wherein a first electrode and a gate electrode of the first TFT are electrically connected to be used as the control terminal of the charging module, and a second electrode of the first TFT is used as the charging/discharging terminal of the charging module,
wherein one electrode of the capacitor is electrically connected to the second electrode of the first TFT, and the other electrode of the capacitor is used as the reference terminal of the charging module.

5. The repair circuit according to claim 3, wherein the input module comprises a second TFT,
wherein a first electrode of the second TFT is used as the input terminal of the input module, a gate electrode of the second TFT is used as the control terminal of the input module, and a second electrode of the second TFT is used as the output terminal of the input module.

6. The repair circuit according to claim 3, wherein the pull-down module comprises a third TFT and a fourth TFT,
wherein a first electrode of the third TFT is used as the first output terminal of the pull-down module, a gate electrode of the third TFT is electrically connected to a gate electrode of the fourth TFT and used as the control terminal of the pull-down module, a second electrode of the third TFT is electrically connected to a second electrode of the fourth TFT and used as the input terminal of the pull-down module,
wherein a first electrode of the fourth TFT is used as the second output terminal of the pull-down module.

7. The repair circuit according to claim 4, wherein the first electrode is a source electrode of the TFT, and the second electrode is a drain electrode of the TFT.

8. The repair circuit according to claim 1, wherein the first level signal is a high level signal.

9. A display substrate comprising the repair circuit according to claim 1, wherein the repair lines are disposed in a non-display region of the display substrate, and each of the repair lines intersects with and is insulated from each drive lead of the display substrate, and wherein a repair point is formed at each intersection.

10. The display substrate according to claim 9, wherein the display substrate further comprises gate lines disposed in its display region, and the gate lines are disposed on the same layer as the drive leads.

11. The display substrate according to claim 9, wherein the display substrate further comprises data lines, and the repair lines are disposed on the same layer as the data lines.

12. The display substrate according to claim 9, wherein the repair lines are disposed within a region adjacent to the display region in the non-display region of the display substrate.

13. The display substrate according to claim 9, wherein the repair lines are disposed on one side of the display substrate, or disposed on two sides of the display substrate.

14. A display panel comprising the display substrate according to claim 9.

15. A repair method for the display substrate according to claim 9, comprising:
welding a repair point formed at an intersection of a first repair line and a drive lead adjacent to a disconnected drive lead, welding a repair point formed at an intersection of a second repair line and the disconnected drive lead, and welding a repair point formed at an intersection of a third repair line and another drive lead adjacent to the disconnected drive lead;
obtaining, by the repair unit, a first adjacent driving signal transmitted on a drive lead adjacent to the disconnected drive lead from the first repair line, obtaining a second adjacent driving signal transmitted on another drive lead adjacent to the disconnected drive lead from the third repair line, generating a first driving signal for driving a gate line connected to the disconnected drive lead based on the first adjacent driving signal and the second adjacent driving signal, and providing the first driving signal to the gate line connected to the disconnected drive lead through the second repair line.

16. The repair circuit according to claim 4, wherein the input module comprises a second TFT,
wherein a first electrode of the second TFT is used as the input terminal of the input module, a gate electrode of the second TFT is used as the control terminal of the input module, and a second electrode of the second TFT is used as the output terminal of the input module.

17. The repair circuit according to claim 4, wherein the pull-down module comprises a third TFT and a fourth TFT,
wherein a first electrode of the third TFT is used as the first output terminal of the pull-down module, a gate electrode of the third TFT is electrically connected to a gate electrode of the fourth TFT and used as the control terminal of the pull-down module, a second electrode of the third TFT is electrically connected to a second electrode of the fourth TFT and used as the input terminal of the pull-down module,
wherein a first electrode of the fourth TFT is used as the second output terminal of the pull-down module.

18. The repair circuit according to claim 5, wherein the pull-down module comprises a third TFT and a fourth TFT,
wherein a first electrode of the third TFT is used as the first output terminal of the pull-down module, a gate electrode of the third TFT is electrically connected to a gate electrode of the fourth TFT and used as the control terminal of the pull-down module, a second electrode of the third TFT is electrically connected to a second electrode of the fourth TFT and used as the input terminal of the pull-down module,
wherein a first electrode of the fourth TFT is used as the second output terminal of the pull-down module.

19. The repair circuit according to claim 16, wherein the pull-down module comprises a third TFT and a fourth TFT,
wherein a first electrode of the third TFT is used as the first output terminal of the pull-down module, a gate electrode of the third TFT is electrically connected to a gate electrode of the fourth TFT and used as the control terminal of the pull-down module, a second electrode of the third TFT is electrically connected to a second electrode of the fourth TFT and used as the input terminal of the pull-down module,
wherein a first electrode of the fourth TFT is used as the second output terminal of the pull-down module.
